(19) United States
(12) Patent Application Publication
(10) Pub. No.: US 2025/0205869 A1
(43) Pub. Date: Jun. 26, 2025

(54) OFFSET HAMMER HANDLE

(71) Applicant: John Riccitelli, San Jose, CA (US)

(72) Inventor: John Riccitelli, San Jose, CA (US)

(21) Appl. No.: 18/986,600

(22) Filed: Dec. 18, 2024

Related U.S. Application Data
(60) Provisional application No. 63/614,311, filed on Dec. 22, 2023.

(51) Int. Cl. B25G 1/10

(52) U.S. Cl. CPC B25G 1/102

(57) ABSTRACT

A hammer tool includes a handle with a lower linear part and an upper extended arcing offset part that begins at a middle portion of the handle above a grip area of the lower linear part. A hammer head is coupled or integrated with the upper extended arcing offset part that continues forward along the handle towards a face of the hammer head.

### CROSS-REFERENCE TO RELATED APPLICATION

This application claims the benefit of U.S. Provisional Application No. 63/614,311, filed on Dec. 22, 2023 entitled: “Offset Hammer Handle”, the contents of which are incorporated by reference herein.

### FIELD OF THE INVENTION

Embodiments of the invention are generally related to a handle for a hammer tool with an elongated offset.

### BACKGROUND

Hammers are used for general carpentry, framing, nail pulling, cabinet making, assembling furniture, bending and shaping metal, and so on. The definition of a hammer is a tool that generally has a wooden, steel or fiberglass handle, and a hammer head that is generally made of metal. A hammer tool can be used to pound a nail into a board. A hammer tool is difficult to use due to an obstruction or in compact areas like a corner of a room or a corner of a cabinet. Existing hammers having straight handles are difficult to use in tight, crowded spaces. These hammers are not able to work around obstructions that are on or near a surface of the work.

### SUMMARY

The handle for this hammer has an elongated offset that puts the handle higher off a working surface of the hammer. The elongated offset of the handle allows a user to work around obstructions that are on or near the surface of the work.

In some embodiments, a hammer tool includes a handle with a lower linear part and an upper extended arcing offset part that begins at a middle portion of the handle above a grip area of the lower linear part. A hammer head is coupled or integrated with the upper extended arcing offset part that continues forward along the handle towards a face of the hammer head.

Other embodiments are also described. Other features of embodiments of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

Following is a brief description of the drawing with reference numbers:

FIGS. 1A, 1B, and 1C illustrate a rear view, front view, and side view, of an extended offset hammer handle in accordance with some embodiments.

FIG. 2 illustrates a side view of the extended offset hammer 104, showing the additional reach 004, 006 of the three different embodiments.

FIG. 3 illustrates in one embodiment additional reach 002 of the extended offset hammer compared to a typical hammer, which is shown directly behind the offset hammer.

FIG. 4 illustrates in one embodiment the additional reach 002 of the extended offset hammer handle and head compared to a typical common hammer, which is shown in front of the offset hammer.

FIGS. 5A and 5B illustrate side views of a longer offset hammer handle embodiment (010B) and longest offset hammer handle embodiment (010C) of the original extended offset hammer handle and head design of FIGS. 1A, 1B, 1C.

FIG. 6 illustrates a side view showing three different embodiments of the ‘extended offset’ hammer handle illustrating the additional reach of the three different versions.

FIG. 7 illustrates an additional reach 002 of the extended offset hammer handle and head, compared to a typical hammer, which is shown in front of the extended offset hammer.

FIG. 8 illustrates an additional reach 002 of the extended offset hammer compared to a typical hammer 012 (shown behind the extended offset hammer).

FIG. 9 illustrates an additional reach 002 of the extended offset hammer 010A, compared to a typical hammer 012 (shown in front of the offset hammer).

FIG. 10 illustrates a slightly curved common hammer handle 030 compared to a longest embodiment of the extended offset hammer 010C.

FIG. 11 illustrates a slightly curved common hammer 030 compared to a longest embodiment of the extended offset hammer 010C.

FIG. 12 illustrates an additional reach of the longer embodiment 010B of the extended offset hammer, compared to the slightly curved common hammer 030.

FIG. 13 shows the additional reach of the longest embodiment 010C of the extended offset hammer, compared to the slightly curved common hammer 030.

FIG. 14 illustrates the impractical striking angle 038 of the slightly curved common hammer 030 compared to the extended offset design 010C when an obstacle is in the way.

FIG. 15 illustrates the impractical striking angle of the common hammer with a longer head 032 compared to the extended offset design 010C when an obstacle is in the way.

FIG. 16 illustrates the additional reach 034 of the longer embodiment (010B) of the extended offset hammer, compared to the common hammer 032.

FIG. 17 illustrates an additional reach 036 of the longest embodiment (010C) of the extended offset hammer, compared to the common hammer 032.

FIG. 18 illustrates a striking tool 1800 having a hatchet head 042 of the extended offset handle design in accordance with one embodiment.

FIG. 19 illustrates a striking tool 1900 having a sledge-hammer head 044 of the extended offset handle design in accordance with one embodiment.

### DETAILED DESCRIPTION

All references cited herein are incorporated herein in their entireties. If there is a conflict between a definition herein and in an incorporated reference, the definition herein shall control. At least one of A, B, and C refers to a selection of A alone, B alone, C alone, a combination of A and B, a combination of A and C, a combination of B and C, or a combination of A and B and C.

When using a hammer there are work situations where obstructions can make it difficult to reach the object or nail the worker is attempting to hit or drive. Similarly, there are many working situations where obstructions can make it very difficult to get a good angle to properly swing a hammer. If the worker tries to strike the nail at an angle other than square with the face of the hammer the result is usually a bent nail. It is important to hit a nail or fastener at an angle square with the face of the hammer. The angle often being dependent on where the intended object or work surface is, and the available clearance, room, or position the worker can get into. Obstructions may be a variety of things such as: wood framing studs, wood blocking, wood beams, electrical conduit, electrical devices, plumbing, sprinkler pipes, and are all common obstructions in construction environments. The obstruction might be larger or deeper, but any number of different situations such as these are encountered while building and working with a hammer.

Offset hammer handle. By extending and offsetting the hammer handle forward in an arc and attaching the handle to the head of the hammer along that curving arc; the hammer can reach around obstructions and objects that would otherwise be in the way of a typical hammer. Any increase in the extension and offset of the handle arc, moves the striking surface of the hammer closer to otherwise difficult to reach areas. Also, limiting the curve on the lower portion of the handle, the hammer is less likely to contact an obstruction immediately in front of the handle. This design may also improve the accuracy of the hammer, because it is easier to control the aim of the head with the handle. Since the handle of the hammer is attached to the head with an arc and closer to the front, the energy and inertia of the handle flows forward into the striking face of the hammer.

In one example, a hammer includes a handle that has an extended offset that curves around common obstructions so to easier reach nails or objects that are out of reach of typical hammers. This hammer handle has a curving elongated offset that puts the handle higher off the working surface thus making it easier to work around obstructions that are on or near the surface of the work. This hammer is also designed so that the bottom end of the handle doesn't curve into the work surface which can interfere with getting a hammer at a practical angle to strike the work. An additional advantage is accuracy, because this hammer's handle attaches at an angle in line with the direction and motion of the swing of the hammer. Since the handle attaches closer to the striking face of the hammer, the handles weight and inertia can follow the direction of the hammer head, thus the striking force of the hammer is improved.

This hammer handle can be made of any strong composition such as steel, fiberglass, plastic, combinations thereof, or any similarly strong material. The offset handle can be attached to the hammer head or be made of one piece of material as in the case of an all steel hammer. The hammer handles ‘head’ need not be any different in shape, or composition, than what is commonly used and marketed already. Most handles have a rubber coating to grip the handle but this does not affect the design of the offset. This handle offset could be used for a variety of different hammer head shapes besides the common nail and carpentry hammers. This offset design of the ‘handle’ makes this hammer better for use in tight, crowded or difficult spaces.

This hammer is also designed so that the bottom end of the handle doesn't curve into the work surface making it easier to angle a nail when there is a surface directly in front of the handle. An additional advantage is accuracy in terms of hitting an intended target, because this hammer's handle attaches at an angle closer to the striking face of the hammer. The handles forward motion and weight improves the direction of the hammer head, making the strike of the hammer more precise.

This present disclosure illustrates the application of an extended offset handle attached to a hammer head. This design is also applicable to other various forms of related handheld striking tools, such as sledgehammers, ball peen hammers, mallets, hatchets, axes and pickaxes. This design pertains more specifically to the ease of working around obstructions, increasing the accuracy, and optimizing the hitting power of such tools.

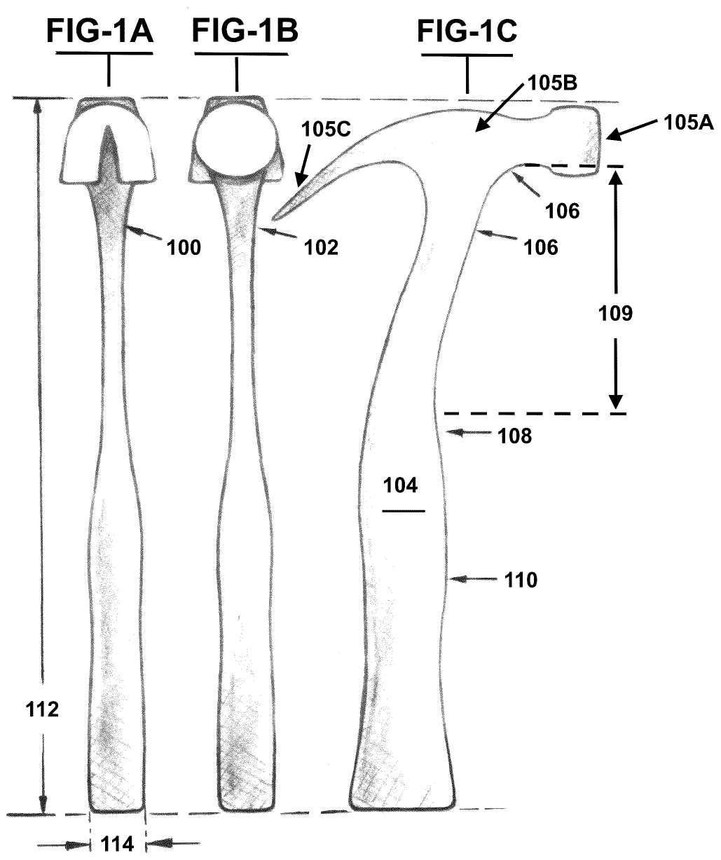

### Reference Numbers for FIGS. 1-19

100—Rear view of extended hammer handle and head
102—Front view of hammer handle and head.
104—Side view of extended offset hammer and head.
105—hammer head having a first face end 105a, an interior region 105b, and a second end 105c.
106—Top part of hammer handle neck offset.
108—Lower part of hammer handle neck offset.
109, 109A, 109B—Upper extended offset part.
110—Hammer handle having a handle grip area (also referred to as lower linear part 110).
112—Length of hammer tool.
114—Width of hammer handle.
002—Additional reach of the ‘extended offset’ hammer handle and head compared to a common hammer.
004—Additional reach of longer embodiment of ‘extended offset’ hammer handle and head compared to a common hammer.
006—Additional reach of longest embodiment of ‘extended offset’ hammer handle and head compared to a common hammer.
008—Difference between the center line of the ‘extended offset’ hammer and what is common to a typical hammer.
010A—The ‘extended offset’ hammer head and handle.
010B—Longer embodiment of ‘extended offset’ hammer.
010C.—Longest embodiment of ‘extended offset’ hammer.
012—Typical conventional hammer.
014—Wooden beam obstruction.
016—Contact point of a hammer handle, and/or the workers hand, contacting an obstruction.
018—Nail (or similar object) that is to be hit with hammer.
020—Most forward leading edge of hammer handle, that meets or touches a surface obstruction.
026—Additional reach of the longer embodiment of ‘extended offset hammer’ compared to a slightly curved hammer.
028—Additional reach of the longest embodiment of the ‘extended offset hammer’ compared to a curved hammer handle of a common hammer.
030—common hammer.
032—common hammer.
034. Additional reach of the longer embodiment of the ‘extended offset hammer’ compared to prior art of a longer head on a straight hammer handle.
036—Additional reach of the longest embodiment of the ‘extended offset’ hammer, compared to prior art of a straight hammer handle with a longer head.
038—Prior art of a hammer head at an impractical angle for striking an object being nailed, stapled, or set, compared to the ‘extended offset’ design. The best angle would be to hit the object at a ninety degree, or square angle.
040—Center line of a typical, common, straight hammer handle.
042—Hatchet head embodiment of ‘extended offset’ handle design.
044—Sledge-hammer embodiment of ‘extended offset’ handle design.

FIGS. 1A, 1B, and 1C illustrate a rear (100) view, a front (102) view, and a side view (104), respectively, of the ‘extended offset’ hammer and head design in accordance with some embodiments. In a first embodiment, the present design has a slight extended offset that begins just above the grip area of the handle (110) near the middle section of the handle, and curves gradually towards the upper part of handle (106) where it meets the hammer head. The handle grip area (110), the length (112), and the width (114) are common to typical hammers. The top part of hammer handle neck offset 106 and lower part of hammer handle neck offset 108 in combination form an upper extended arcing offset part 109.

This first embodiment of the design comprises a handle with a slight offset that begins at the lower portion of the handle 108 and continues upward towards the top end of the handle and attaches to the underside of the hammer head. Other embodiments illustrate how the curvature can continue from the grip area upwards all the way to the most forward part of the hammer and attach just under the striking surface (e.g., striking face) of the hammer.

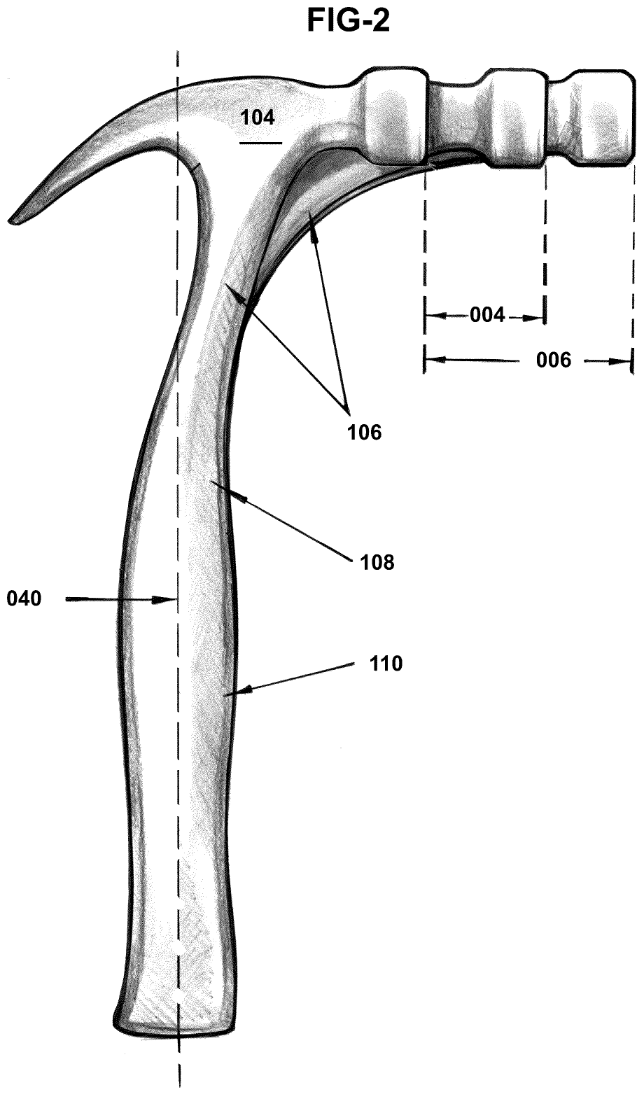

FIG. 2 illustrates an extended offset hammer tool in accordance with some embodiments. The additional reach 004 illustrates the additional reach of a longer embodiment of the offset hammer, and additional reach 006 illustrates the additional reach of the longest embodiment of the extended offset hammer. The first embodiment of this design (104) has a slight offset that begins above the grip portion of the handle (108) and continues upward along the handle (106) and attaches at an angle under the head of the handle. The different embodiments illustrate extended offsets that begin just above the area where a worker's hand typically grasps the handle, and curve gradually or extensively depending on which embodiment is considered. The centerline (040) illustrates the center of the grip portion of a hammer handle.

The handle of the hammer tool curves towards a striking face of the hammer head in order to reach around obstacles, without depending on a length of the hammer head to make up the difference in reach. These different embodiments illustrate handles that arc and attach progressively closer to the striking face of the hammer. By attaching the handle closer to the striking face of the hammer head, it is easier to control the forward direction of the striking face of the hammer. This design also creates a better striking inertia as well because less energy is wasted when the force of the hammer accurately and squarely lands on a targeted work surface because the hammers striking accuracy is improved.

The slight curvature shown in the extended offset hammer and head 104 extends enough to give greater reach than a typical hammer. Any additional increase in the extension is also an improvement in reach, effectiveness, and benefits when working around obstacles. An embodiment of the hammer extension that is most effective depends on the workers needs and work environments.

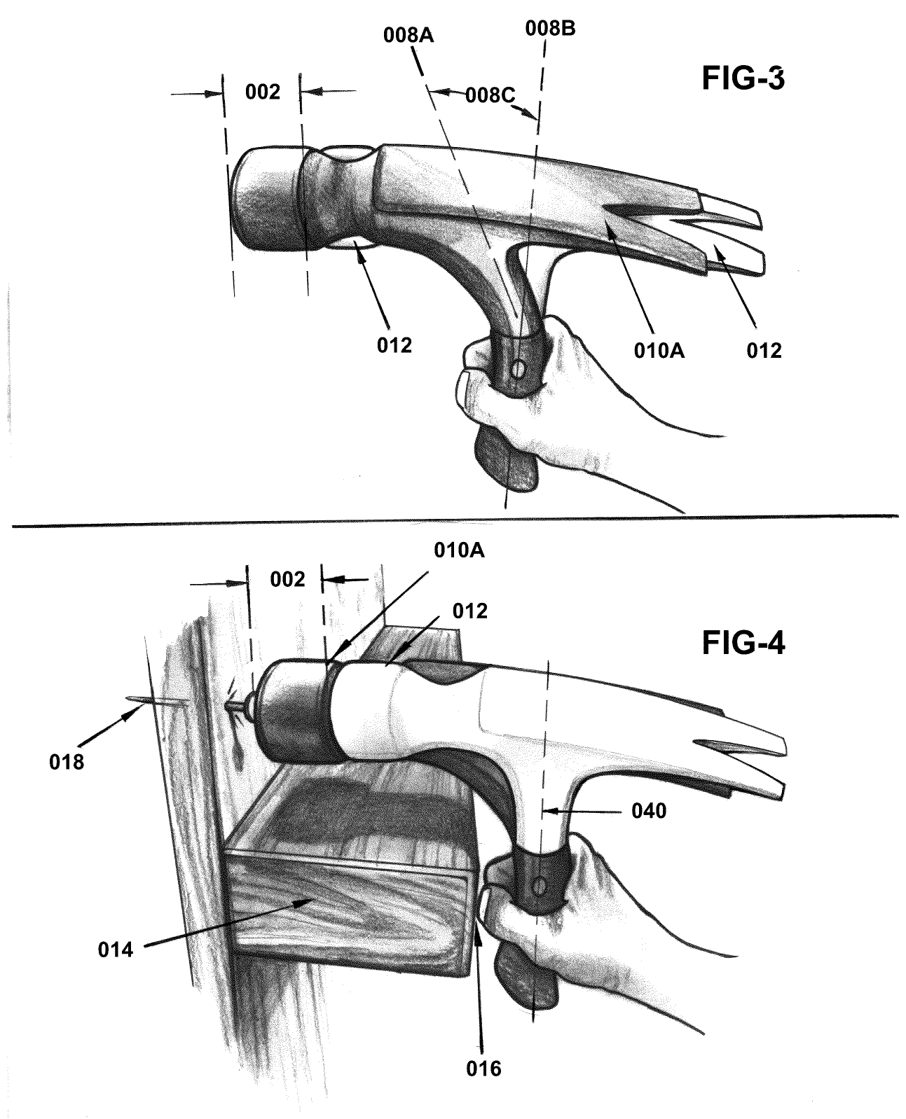

FIG. 3 illustrates an additional reach (002) of the extended offset hammer handle (010A), compared to a typical hammer (012) which is shown directly behind the offset hammer. The additional reach is illustrated as the difference between broken lines and the arrows shown in 002. FIG. 3 also illustrates an angular difference 008c between a center line 008a of the extended offset hammer design and the centerline 008b of a common typical hammer.

FIG. 4 illustrates the additional reach 002 of the extended offset hammer handle and head (010A) shown in dark shading, compared to a typical hammer (012) shown with light shading, which is shown in front of the offset hammer. FIG. 4 also shows the worker's hand contacting an obstruction 016. The obstruction 014 prevents the worker from getting closer to a work surface for pounding a nail into a board, but the extended reach 002 of the offset allows the worker to strike the object or nail 018 as illustrated in this example.

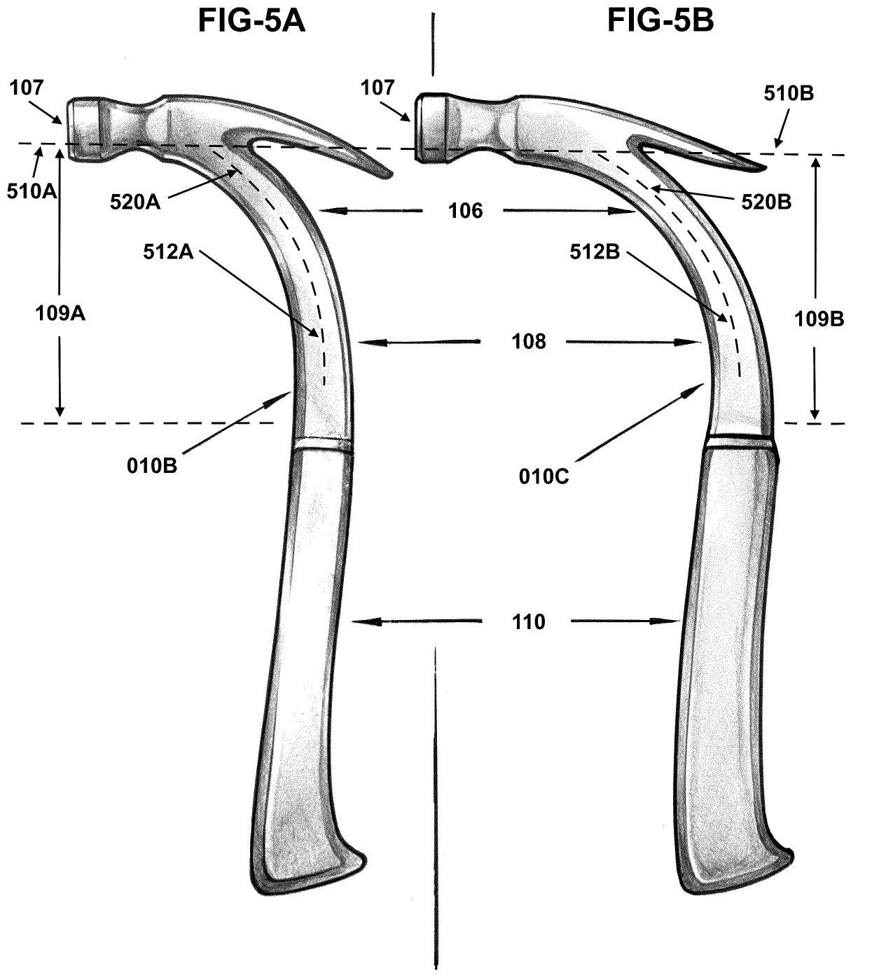

FIGS. 5A and 5B illustrate side views both for a longer embodiment 010B in FIG. 5A and longest embodiment 010C in FIG. 5B. These are both longer embodiments of the original extended offset hammer handle of FIGS.—1A, 1B, and 1C. The upper extended arcing offset part 109 of the handle just above the grip area curves forward and attaches or joins at an angle 512a, 512b under the hammer head 105 and a striking surface 107 at the front of the hammer head. The upper extended offset part 109a, 109b forms an angle 520a, 520b (e.g., 25-65 degrees, 35-55 degrees) with a centerline 510a, 510b of the hammer head that passes through a face of the hammerhead. The handle grip area of the hammer handle 110 down to the bottom end of the handle purposefully does not continue to curve towards the front or ‘working side’ of the hammers, so as not to impede the hammers effectiveness when used near flat surfaces or other obstructions in front of the handle and the workers hand.

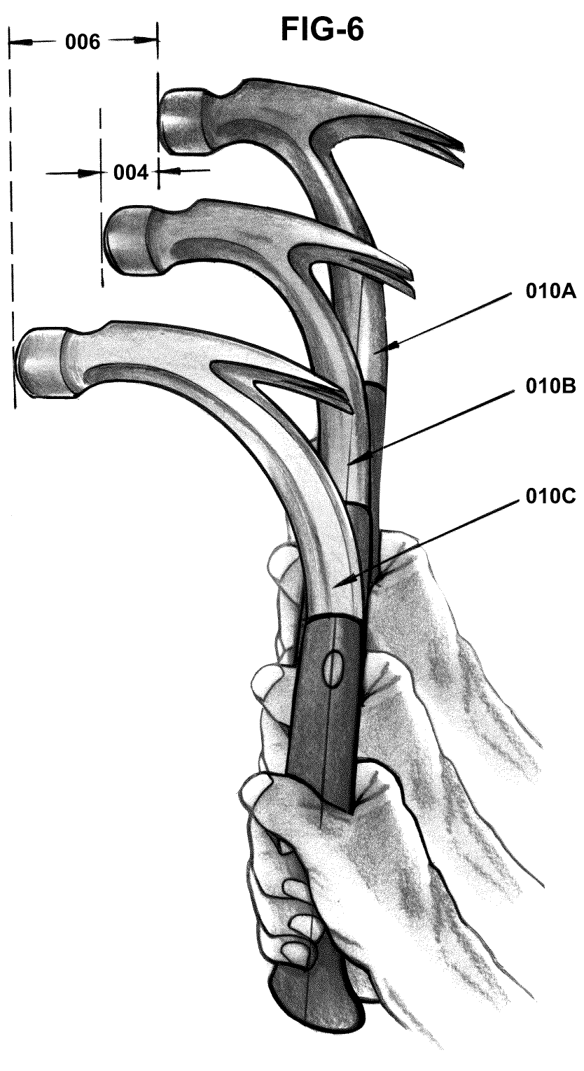

FIG. 6 illustrates a side view showing three different embodiments of the ‘extended offset’ hammer handle illustrating the additional reach (e.g., 004, 006) of the three different embodiments (010A, 010B, 010C) layered on top of each other to illustrate the increased reach of each embodiment. The difference in reach and length between each embodiment is not essential to the basic function that either of the extended offset hammers are designed. The different lengths illustrated here only express what the different possibilities might look like such as ranging from a slight offset to an aggressively longer offset. Any specific lengths are not intended by the illustrations.

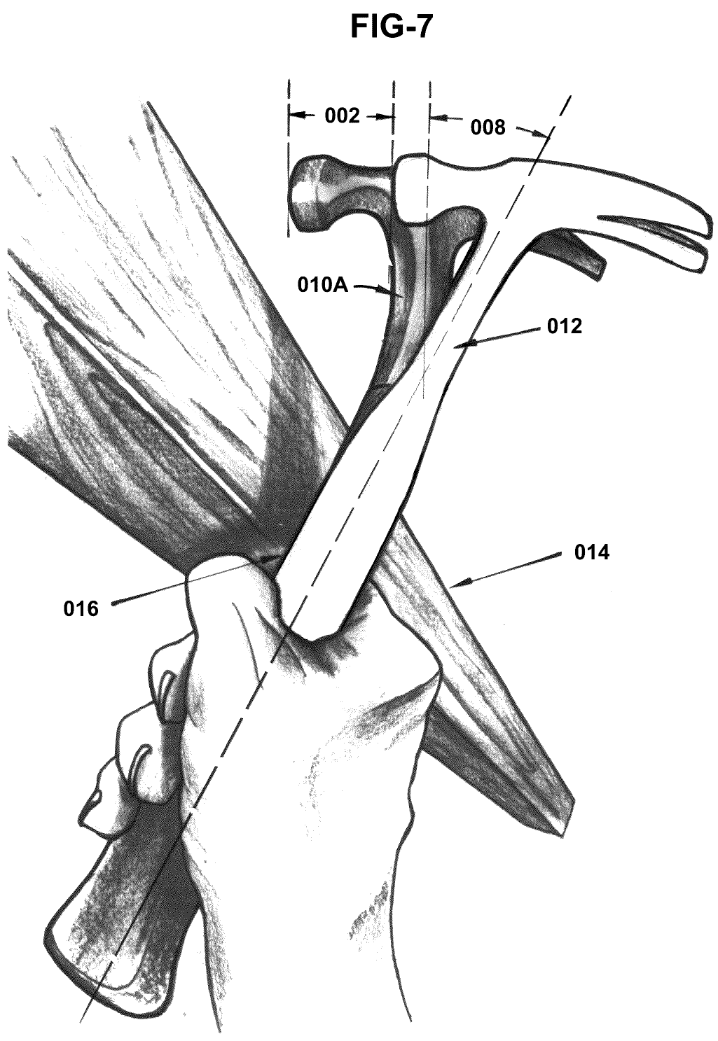

FIG. 7 shows the additional reach 002 of the extended offset hammer handle and head 010A in dark shading, compared to a typical common hammer 012 which is shown in front of the offset hammer 010A. FIG. 7 also shows where the lower edge of the hammer handle as well as the workers hand are restricted by 016 due to an obstruction 014. The obstruction illustrated here is just an example of what a common obstruction might be. The obstruction might be larger or deeper, but it is commonly a board, pipe or item such as this. FIG. 7 also illustrates the difference 008 between the centerline of an upper extended offset part of the extended offset hammer handle and the centerline (shown with dotted line) of a typical hammer. The difference in the amount of offset depicted by the arrows of 008 is variable, but any extended offset in the hammer handle, as illustrated here, would be an improvement over the reach of a typical hammer.

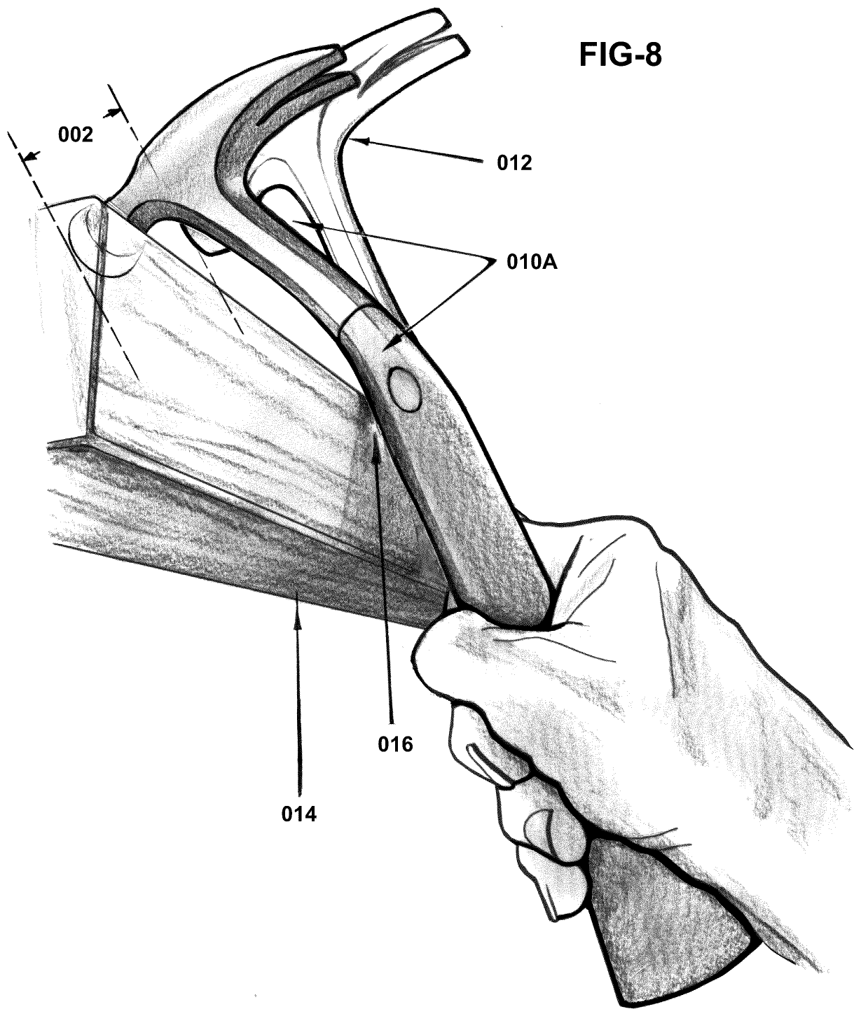

FIG. 8 shows the additional reach 002 of the extended offset hammer handle and head 010A in dark shading (shown in front of a typical hammer), compared to a typical hammer 012 (shown behind the extended offset hammer). Also showing where the hammer handle held in the workers hand contacts 016 at an obstruction 014. The contact area 016 illustrates where the middle area of a hammer handle is restricted by an obstruction 016 such as the wood beam illustrated here. FIG. 7 illustrates where the lower area of the handle might be restricted by an obstacle, and FIG. 8 illustrates an angle where an upper area of the handle might be restricted by an obstacle 014 as shown with contact area 016.

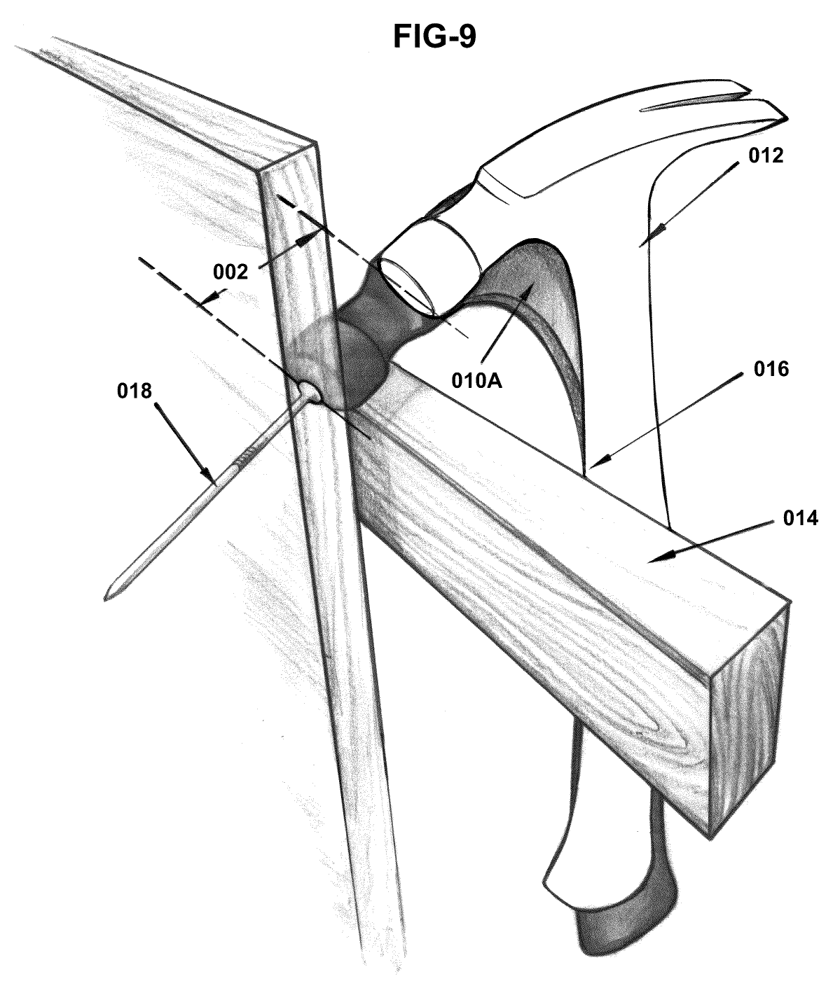

FIG. 9 shows an additional reach 002 of the extended offset hammer 010A, compared to a typical hammer 012. The additional reach is illustrated by the difference between the dotted lines and the arrows shown in 002. Also showing where the hammer handle is restricted by or contacts an obstruction (016) such as the wood board (014) shown here. Also illustrating a nail (018) that is to be hit with the striking surface of the hammer. This helps illustrate the additional reach that the extended offset hammer has over a typical hammer (012).

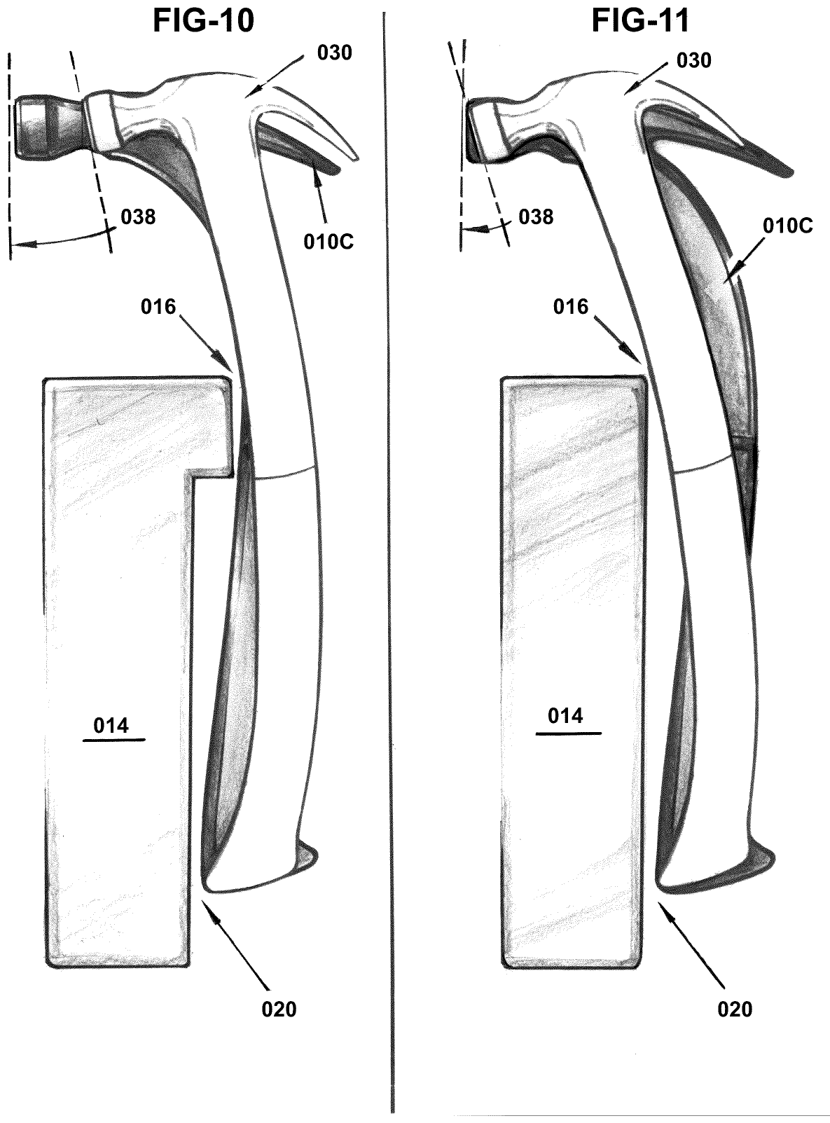

FIG. 10 shows the slightly curved hammer handle from a common hammer 030 in light shading compared to the longest embodiment of the extended offset hammer 010C shown just behind the hammer 030. Illustrating here that the slightly curved hammer handle 030 of the prior art does not reach as far when compared to the ‘extended offset’ design 010C. In this example the hammer 030 is at a disadvantage because of the impractical angle 038 for striking an object being nailed, stapled, or set. The impractical angle is illustrated as the difference between the dotted lines with arrow of 038. This is to illustrate how the extended offset design is an improvement over other versions of curved handles that were not designed to work with difficult depths, and or not designed for an extended reach when working around obstacles. The continuous curve at the bottom end of a handle of the hammer 030 further restricts typical inward curving handles from getting closer to the work when an obstruction is present.

FIG. 11 showing a slightly curved hammer handle of the common hammer 030 that is at a disadvantage when compared to the longest embodiment of the extended offset hammer 010C in accordance with one embodiment. FIG. 11 illustrates that the slightly curved hammer handle of hammer 030 is at an impractical angle 038 for striking an object being nailed, stapled, or set, compared to the extended offset design 010C. The impractical angle is illustrated as the difference between the dotted lines with arrow of 038. It is best to hit the nail head or targeted object with a striking surface (face) of the hammer head being parallel to the nail head or targeted object, as the extended offset hammer can do in this comparison. The obstruction illustrated here is restricting with contact area 016 the hammer handle and head from reaching and striking the work surface at a practical angle to hit the nail head or targeted object flush instead of at any angle 038 that will result in nail being bent. The extended offset hammer (010C) is shown just behind the hammer 030.

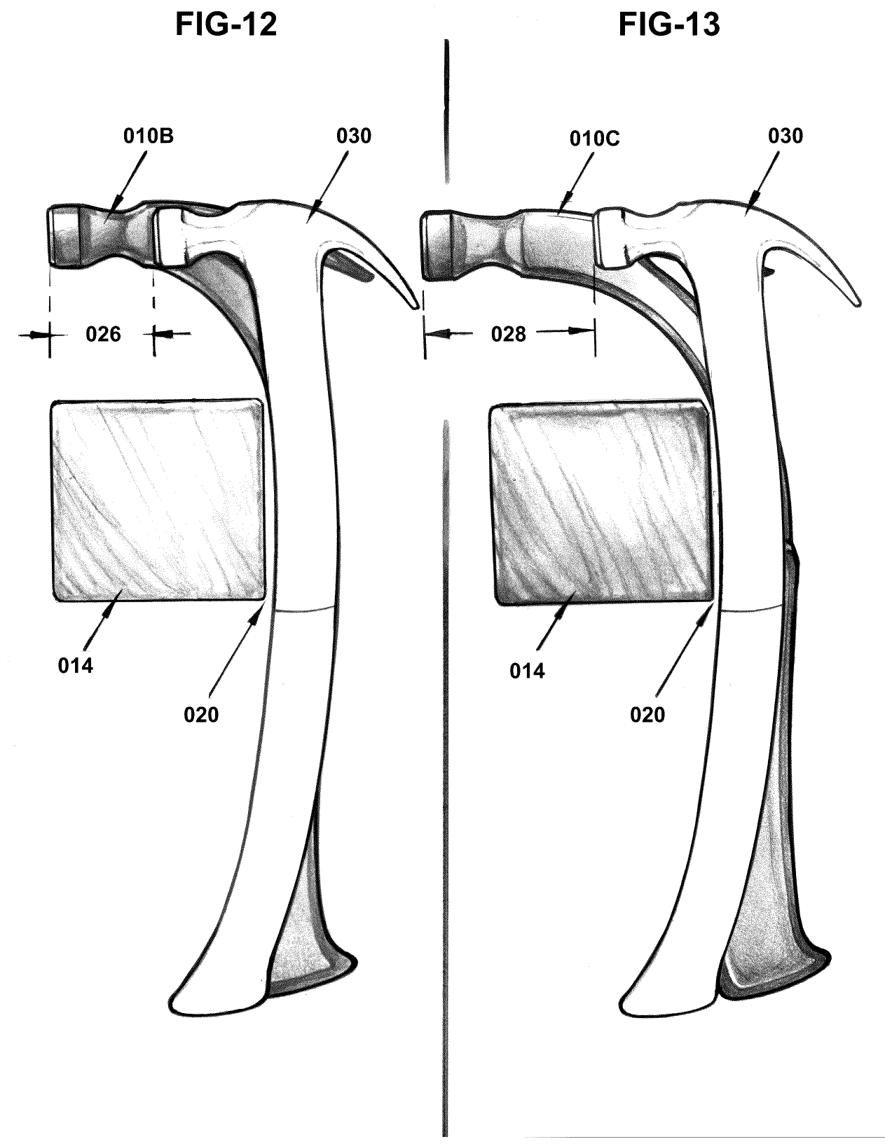

FIG. 12 shows the additional reach 026 of the longer version 010B of the extended offset hammer handle and head, compared to the slightly curved common hammer 030. Contact area 020 illustrates where the most forward leading edge of the hammer handle is restricted by or touches an obstruction 014. The extended offset hammer 010B is shown just behind the hammer 030.

FIG. 13 shows the additional reach 028 of the longest version 010C of the extended offset hammer handle, compared to the slightly curved hammer handle in the common hammer 030. Contact area 020 illustrates where the most forward leading edge of the hammer handle is restricted by or touches an obstruction 014. Note also that the handle of the hammer 030 curves forward where it may contact a flat wall or an obstruction. This would prevent the worker's hand and hammer from getting closer to the work. The extended offset hammer 010C is shown just behind the hammer 030.

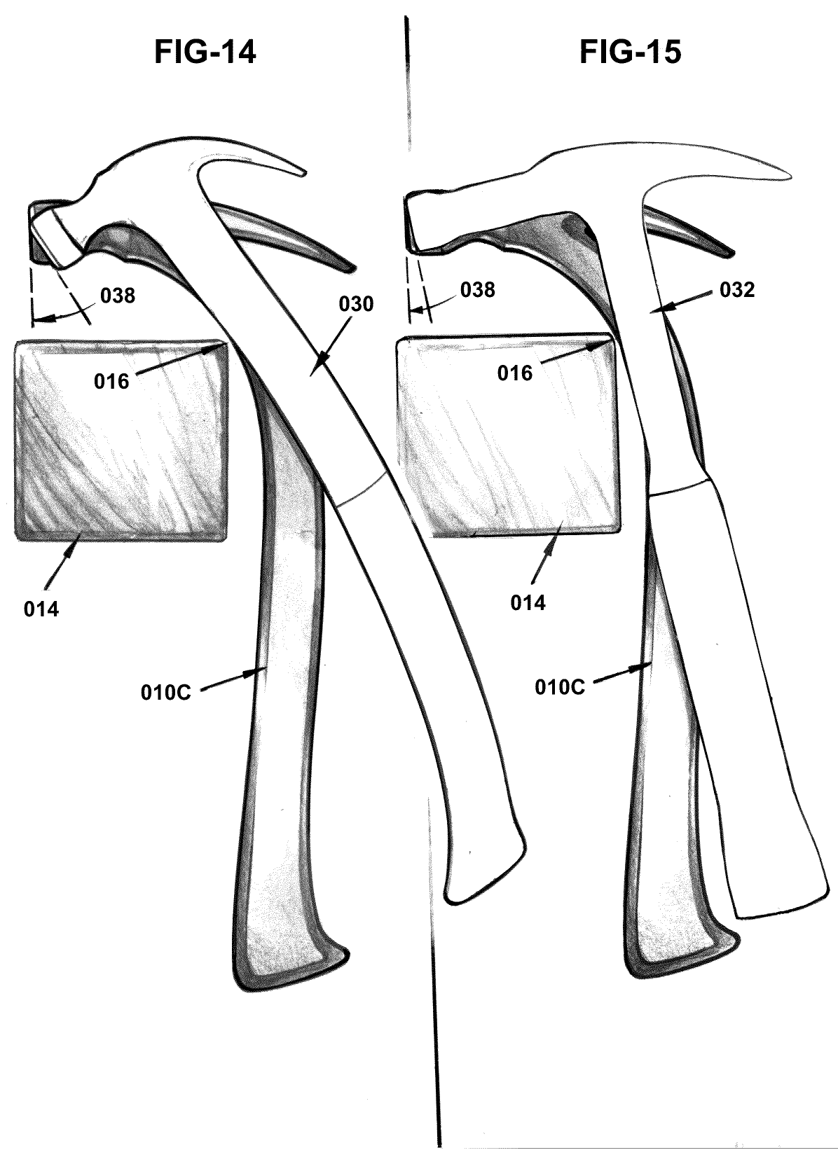

FIG. 14 shows an impractical striking angle 038 of the slightly curved common hammer 030 compared to the extended offset design 010C when an obstacle 014 is in the way. Contact area 016 shows where the hammer handle is being restricted by an obstruction such as a block of wood 014. The extended reach of the extended offset hammer is shown to be an improvement over the slightly curved handle from the hammer 030. The extended offset hammer 010C is shown just behind the common hammer 030.

FIG. 15 shows an impractical striking angle 038 of the common hammer 032 with a longer head, compared to the extended offset hammer design 010C when an obstacle is in the way. Contact area 016 shows where the hammer handle is being restricted by an obstruction 014. The extended reach of the extended offset hammer is shown to be an improvement over the slightly curved handle of the hammer 032. The extended offset hammer 010C is shown just behind the hammer 032.

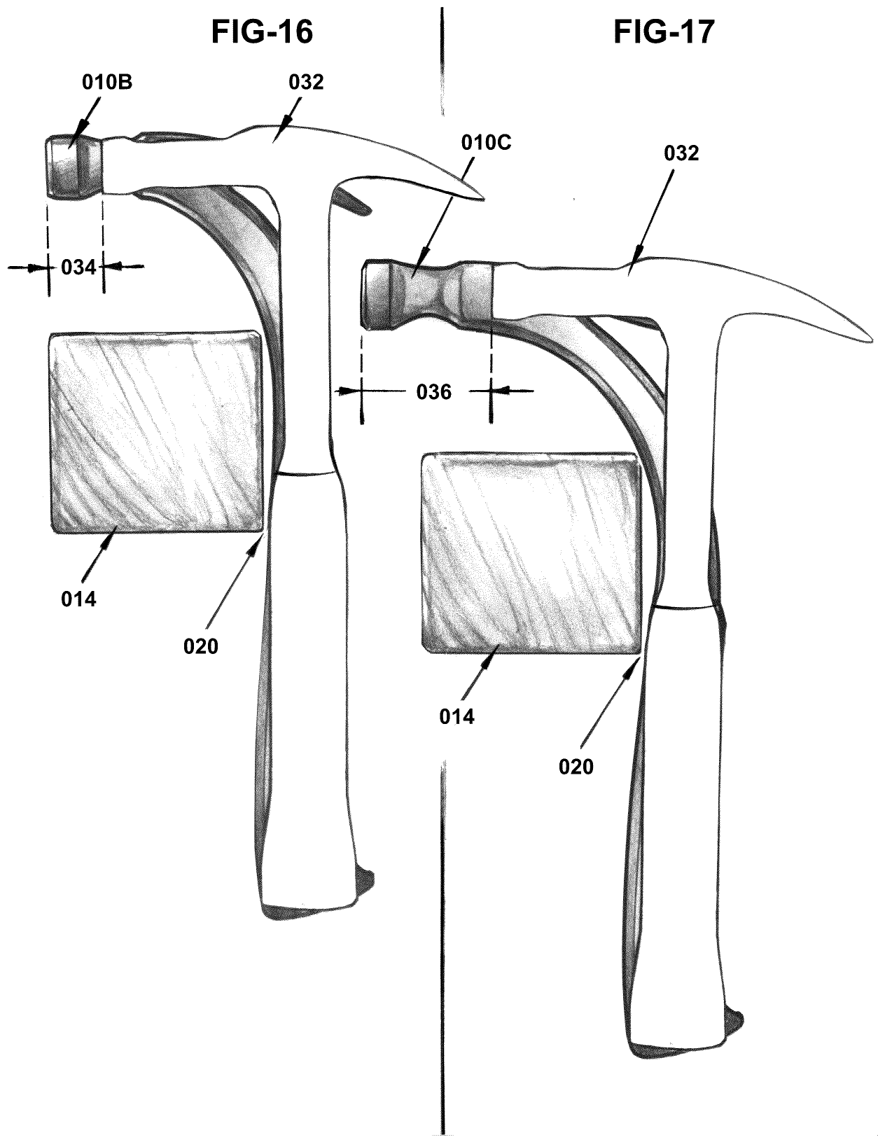

FIG. 16 shows an additional reach 034 of the 010B extended offset hammer, compared to the common hammer 032. The additional reach is illustrated by the difference between the arrows shown in additional reach 034. Also, FIG. 16 shows the most forward leading edge of the hammer handle 020 that meets or touches a surface obstruction such as a block of wood 014 as illustrated here.

FIG. 17 shows the additional reach 036 of the longest embodiment 010C of the extended offset hammer compared to the common hammer 032. The additional reach is illustrated by the difference between the arrows shown in the additional reach 036. FIG. 17 also shows the most forward leading edge of the hammer handle 020 that meets or touches a surface obstruction 014.

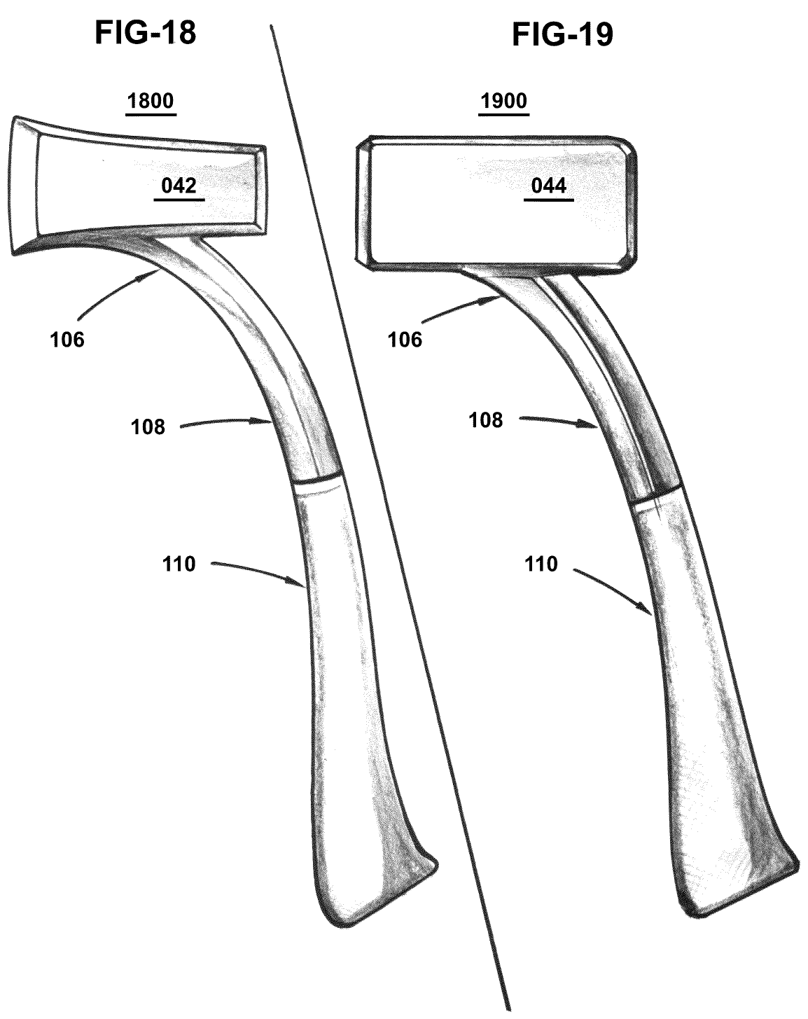

FIG. 18 illustrates a striking tool 1800 having a hatchet/axe head 042 with an extended offset handle design in accordance with one embodiment. The offset improves the hatchet/axe head reach when working around obstructions such as other tree branches. This design also improves accuracy for striking a target because the weight forward design causes the axe head to fall forward towards the cutting edge of the hammer.

FIG. 19 shows a striking tool 1900 having a sledge-hammer head 044 of the extended offset handle design in accordance with one embodiment. The offset makes it easier to work around obstructions such as rocks, pieces of concrete, pipes, rebar, etc. This design also improves the striking power because the weight forward design causes the head to fall towards the face of the hammer rather than to the side as with typical straight handles.

The difference in the amount of offset of each embodiment is variable, but any extended offset in the hammer handle, as illustrated as in FIG. 6, would be an improvement over the reach of a typical hammer. The additional differences in reach and length between each successive embodiment, as illustrated as in FIG. 6, does not change the basic function or intention of the extended offset hammer design.

The different lengths illustrated herein in the embodiments of FIG. 6 only express what the different possibilities might look like, ranging from a slight offset to a longer offset. Any specific lengths are not intended by the illustrations. The additional reach of the offset can be manufactured to extend in lengths even further than what is illustrated here, but the different lengths shown here would be long enough for most any situation where an extended reach is needed.

The terminology used herein is for the purpose of describing various embodiments only and is not intended to be limiting of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

This hammer handle has an elongated offset that puts the handle higher off the working surface as illustrated in FIG. 4 and FIGS. 7 thru 9, thus making it easier to work around obstructions that are on or near the surface of the work.

This hammer is designed to keep the handle further from the surface of the work so to make it easier to drive a nail at an angle. When the bottom edge of a typical hammer handle 020 touches the work surface it limits the angle at which the user may want to drive a nail. Often a worker wants to drive a nail at an angle, but the bottom end of the hammer limits the angle when the handle is too close to a work surface.

An additional advantage of the present design is accuracy, because this hammers design puts the forward motion and direction of the handle closer to the striking face of the hammer, the strike of the hammer is more precise. This also increases the hitting power, as an accurate strike means more inertia is directed at the intended object and not lost by being off center.

The obstructions illustrated herein are just examples of what a common obstruction might be. The obstruction might be larger or deeper, but any number of different situations such as these are encountered while building and working with a hammer.

Note that the common hammer 030 curves forward towards the working side of the hammer where it may be impeded by a flat wall or an obstruction. This would prevent the workers hand and hammer from getting closer to the work surface.

In various Figures the common hammers are at a disadvantage because of the impractical angles (038) for striking an object being nailed, stapled, or set. The best angle would be to hit the object at a ninety degree, or square angle, as the extended offset hammer is able to do in this comparison. The obstructions shown herein are restricting at contact area 016 for the hammers handle and head and prevent the hammer from reaching and striking the work surface at a practical angle. This is to illustrate how the extended offset design is an improvement over other versions of curved handles not designed to work with difficult depths, and/or not designed for an extended reach when working around obstacles. The continuous curve at the bottom end of the common hammer 030 further restricts this design from getting closer to the work when an obstruction is present.

This hammer tool having an upper extended offset part of a handle can be made of any strong composition such as steel, fiberglass, plastic, combinations thereof, or any similarly strong material. The offset handle can be attached to the hammer head or be made of one piece of material as in the case of a steel hammer. The hammer handle's ‘head’ need not be any different in shape or composition than what is commonly used and marketed already. Most handles have a rubber coating for grip but this does not affect the design of the offset. This handle offset could be used for a variety of different hammer head shapes besides common nail and carpentry hammers; i.e. ball peen, sledge, mallet, and sheet metal hammers, etc.

According to some embodiments for Example 1, a hammer tool, comprises a handle with a lower linear part and an upper extended arcing offset part that begins at a middle portion of the handle above a grip area of the lower linear part and a hammer head coupled or integrated with upper extended arcing offset part that continues forward along the handle towards a striking face of the hammer head.
Example 2 includes the subject matter of Example 1, wherein the upper extended arcing offset part includes a pronounced curve that begins at the middle portion of the handle above the grip area and continues to arc forward along the handle towards the face of the hammer and attaches under the hammer head of the hammer at an angle between 25 degrees and 55 degrees, just behind or under the striking face of the hammer head.
Example 3 includes the subject matter of any of Examples 1-2, wherein the upper extended arcing offset part joins under the hammer head of the hammer at an angle between 40 degrees and 50 degrees.
Example 4 includes the subject matter of any of Examples 1-3, wherein the upper extended arcing offset part further comprises a top part having a first end that joins the hammer head and a lower part that joins a second end of the top part.
Example 5 includes the subject matter of any of Examples 1-4, wherein the upper extended arcing offset part includes a first end that joins an interior region of the hammer head and a second end that joins the lower linear part and the upper extended arcing offset part provides an offset of 2 to 3 inches from the first end to the second end.
Example 6 includes the subject matter of any of Examples 1-5, wherein the upper extended arcing offset part includes a first end that joins an interior region of the hammer head and a second end that joins the lower linear part and the upper extended arcing offset part provides an offset of 3 to 4 inches from the first end to the second end.
Example 7 includes the subject matter of any of Examples 1-6, wherein the upper extended arcing offset part provides an offset from a working surface to improve an ability to use the hammer tool near the working surface.
Example 8 includes the subject matter of any of Examples 1-7, wherein the hammer tool comprises a nail hammer, a carpentry hammer, a ball peen hammer, a sledge hammer, a mallet, or a sheet metal hammer.
Example 9 includes the subject matter of any of Examples 1-8, wherein the lower linear part remains straight or turns away from a working surface in front of the striking face of the hammer tool.
Example 10 includes the subject matter of any of Examples 1-9, wherein the upper extended arcing offset part has a pronounced curve that begins at a middle portion of the handle above a grip area, while a bottom portion of the lower linear part from the grip area down remains straight and purposefully curves away from a forward striking side of the hammer tool.
Example 11 includes the subject matter of any of Examples 1-10, wherein the upper extended arcing offset part is designed to curve around an obstruction while objectively moving the striking face closer to an intended target or nail.
Example 12 includes the subject matter of any of Examples 1-11, wherein the upper extended arcing offset part is designed to curve forward with a purpose of reaching out and around an obstacle when the handle is impeded by that obstacle or another object directly in front of an intended work surface.
Example 13 includes the subject matter of any of Examples 1-12, wherein the upper extended arcing offset part is designed to curve forward towards a striking face of the hammer head in order to reach around obstacles without depending on a length of the hammer head to provide reach.
Example 14 includes the subject matter of any of Examples 1-13, wherein the handle curves forward towards the striking face of the hammer head and since the handle is attached closer to the striking face of the hammer head this provides improved control for striking accuracy of both the hammer head and the striking face of the hammer head.
Example 15 includes the subject matter of any of Examples 1-14, wherein the handle is attached at an angle close to the striking face of the hammer, which results in improved striking accuracy, and also better utilizes energy of the striking force because of the improved striking accuracy.
Example 16 includes the subject matter of any of Examples 1-13, wherein the lower linear part does not curve forward towards a forward edge of the hammer head so as not to impede the hammer tool effectiveness when used near flat surfaces or other obstructions in front of a user.
Example 17 includes the subject matter of any of Examples 1-16, wherein the handle begins to curve after a grip area and continues to arc and curve upwards to a cheek, neck, and face of the hammer head.

According to some embodiments for Example 18, a striking tool, comprises a handle with a lower linear part and an upper extended arcing offset part that begins at a middle portion of the handle above a grip area of the lower linear part and a head coupled or integrated with upper extended arcing offset part that continues forward along the handle towards a striking face of the head.

According to some embodiments for Example 19, wherein the upper extended arcing offset part includes a pronounced curve that begins at the middle portion of the handle above the grip area and continues to arc forward along the handle towards the face of the head and attaches under the head of the striking tool at an angle between 25 degrees and 55 degrees, just behind or under the striking face of the head.
Example 20 includes the subject matter of Example 19, wherein the striking tool comprises an ax, a hatchet, a sledge-hammer, or a mallet.

In the foregoing specification, the present design has been described with reference to specific exemplary embodiments thereof. It will be evident that various modifications may be made thereto without departing from the broader spirit and scope of the present design as set forth in the following claims. The specification and drawings are, accordingly, to be regarded in an illustrative sense rather than a restrictive sense.

What is claimed is:

1. A hammer tool, comprising:
a handle with a lower linear part and an upper extended arcing offset part that begins at a middle portion of the handle above a grip area of the lower linear part; and
a hammer head coupled or integrated with upper extended arcing offset part that continues forward along the handle towards a striking face of the hammer head.

2. The hammer tool of claim 1, wherein the upper extended arcing offset part includes a pronounced curve that begins at the middle portion of the handle above the grip area and continues to arc forward along the handle towards the face of the hammer and attaches under the hammer head of the hammer at an angle between 25 degrees and 55 degrees, just behind or under the striking face of the hammer head.

3. The hammer tool of claim 2, wherein the upper extended arcing offset part joins under the hammer head of the hammer at an angle between 40 degrees and 50 degrees.

4. The hammer tool of claim 1, wherein the upper extended arcing offset part further comprises:
a top part having a first end that joins the hammer head; and
a lower part that joins a second end of the top part.

5. The hammer tool of claim 1, wherein the upper extended arcing offset part includes a first end that joins an interior region of the hammer head and a second end that joins the lower linear part and the upper extended arcing offset part provides an offset of 2 to 3 inches from the first end to the second end.

6. The hammer tool of claim 1, wherein the upper extended arcing offset part includes a first end that joins an interior region of the hammer head and a second end that joins the lower linear part and the upper extended arcing offset part provides an offset of 3 to 4 inches from the first end to the second end.

7. The hammer tool of claim 1, wherein the upper extended arcing offset part provides an offset from a working surface to improve an ability to use the hammer tool near the working surface.

8. The hammer tool of claim 1, wherein the hammer tool comprises a nail hammer, a carpentry hammer, a ball peen hammer, a sledge hammer, a mallet, or a sheet metal hammer.

9. The hammer tool of claim 1, wherein the lower linear part remains straight or turns away from a working surface in front of the striking face of the hammer tool.

10. The hammer tool of claim 1, wherein the upper extended arcing offset part has a pronounced curve that begins at a middle portion of the handle above a grip area, while a bottom portion of the lower linear part from the grip area down remains straight and purposefully curves away from a forward striking side of the hammer tool.

11. The hammer tool of claim 1, wherein the upper extended arcing offset part is designed to curve around an obstruction while objectively moving the striking face closer to an intended target or nail.

12. The hammer tool of claim 1, wherein the upper extended arcing offset part is designed to curve forward with a purpose of reaching out and around an obstacle when the handle is impeded by that obstacle or another object directly in front of an intended work surface.

13. The hammer tool of claim 1, wherein the upper extended arcing offset part is designed to curve forward towards a striking face of the hammer head in order to reach around obstacles without depending on a length of the hammer head to provide reach.

14. The hammer tool of claim 1, wherein the handle curves forward towards the striking face of the hammer head and since the handle is attached closer to the striking face of the hammer head this provides improved control for striking accuracy of both the hammer head and the striking face of the hammer head.

15. The hammer tool of claim 1, wherein the handle is attached at an angle close to the striking face of the hammer, which results in improved striking accuracy, and also better utilizes energy of the striking force because of the improved striking accuracy.

16. The hammer tool of claim 1, wherein the lower linear part does not curve forward towards a forward edge of the hammer head so as not to impede the hammer tool effectiveness when used near flat surfaces or other obstructions in front of a user.

17. The hammer tool of claim 1, wherein the handle begins to curve after a grip area and continues to arc and curve upwards to a cheek, neck, and face of the hammer head.

18. A striking tool, comprising:
a handle with a lower linear part and an upper extended arcing offset part that begins at a middle portion of the handle above a grip area of the lower linear part; and
a head coupled or integrated with upper extended arcing offset part that continues forward along the handle towards a striking face of the head.

19. The striking tool of claim 18, wherein the upper extended arcing offset part includes a pronounced curve that begins at the middle portion of the handle above the grip area and continues to arc forward along the handle towards the face of the head and attaches under the head of the striking tool at an angle between 25 degrees and 55 degrees, just behind or under the striking face of the head.

20. The striking tool of claim 18, wherein the striking tool comprises an ax, a hatchet, a sledge-hammer, or a mallet.
